(19) United States
(12) Patent Application Publication
(10) Pub. No.: US 2007/0218444 A1
(43) Pub. Date: Sep. 20, 2007

(54) System and method for presenting karaoke audio features from an optical medium

(76) Inventors: David Konetski, Austin, TX (US); Thomas L. Pratt, Austin, TX (US)

Correspondence Address: HAMILTON & TERRILE, LLP, P.O. BOX 203518, AUSTIN, TX, 78720, US

(21) Appl. No.: 11/366,251

(22) Filed: Mar. 2, 2006

(51) Int. Cl. G09B 5/00

(52) U.S. Cl. 434/307 A

(57) ABSTRACT

An optical medium, such as Blu-ray Disc (BD) medium, presents audiovisual information in a user selected Karaoke mode by mixing first and second audio streams and a textual stream according to synchronization information. For instance, the first stream has instrumentation and the second stream has vocals so that the audio output from the streams may include normal play mixing both streams to have instrumentation and vocals, instrumentation-only play having only one stream presented, or instrumentation with guide vocals having the stream associated with vocals processed at a subdued volume or varied speaker location. Alternatively, the first stream has instrumentation with vocals and the second stream has inverse vocals so that mixing the streams provides subdued or no vocals. The text stream presents lyrics in a text box of a graphics plane of a display, the lyrics synchronized to the instrumentation and vocals.

### BACKGROUND OF THE INVENTION

1. Field of the Invention

The present invention relates in general to the field of presenting audio information, and more particularly to a system and method for presenting Karaoke audio features from an optical medium with an information handling system optical drive.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling systems have transformed the entertainment industry. One example of this is the use of optical media to store and present audio and visual information. For instance, Compact Disc (CD) optical media, which interact with an infrared laser to store and read information, are commonly used to store albums of music. Similarly, Digital Versatile Discs (DVD) optical media, which interact with a red laser to store and read information, are commonly used to store movies for commercial sale. One popular usage model for audio and video playback from CD and DVD media is Karaoke, during which individuals sing to popular music with vocals of the music removed or played at a subdued volume. Generally Karaoke CDs are uniquely authored at extra expense to have a facsimile of the original musical work with guide vocals and a second set of tracks having the music accompaniment without any vocals. The unique preparation of Karaoke discs tends to increase the price relative to other discs and reduce the available selection. Essentially, Karaoke music is purchased twice, once for Karaoke play and once for general playback. Some solutions have sought to support Karaoke play from ordinary soundtracks, such as the Creative Labs Audigy sound cards, which use a DSP algorithm for sound analysis and frequency cancellation of vocals.

In some instances, Karaoke discs include visual accompaniment, such as display of music lyrics. For instance, CD-G format uses Subchannel data to carry graphics commands and data. The subchannel data is a 16 byte data field with a data stream created at each bit by a succession of the bits in the bit location labeled P thru W. Audio production CDs do not use bits R through W, however, Karaoke CDs use the approximately 3.6 K of data each second supported by bits R through W to carry a simple graphics command language that tells a graphics engine on a Karaoke player how to render the lyrics as simple graphics on a screen. DVD media generates lyrics through a DVD Subpicture that is essentially a graphics plane behind the video plane. The graphics and video planes are mixed in a deterministic and definable way to render the lyrics as part of the subpicture synchronized with the audio track.

Recently, a new type of optical medium has been developed that uses a blue laser to read and write information, such as with the Blu-ray Disc (BD) or High Definition DVD specifications. One advantage of blue laser media is that the smaller wavelength of the blue laser compared with infrared and red lasers allows greater storage density for blue laser optical media. This greater storage density provides capacity to hold feature length High Definition movies and support desirable additional features, such as functions controlled by BD-Java (BD-J) applications running through a Blu-ray Disc per the Blu-ray specification. For example, a Blu-ray optical disc provides a unique audiovisual architecture having primary and secondary audio streams, a Movie Plane for presentation of video, a Presentation Graphics Plane and an Interactive Plane as well as a separate text subtitling stream which is rendered as a text box within the graphics plane. The primary and secondary audio streams are mixed and provided to the rendering engine for presentation to allow, for instance, a secondary audio having an explanation of a movie associated with a picture-in-picture (PIP) box while the movie and its primary audio play normally in the Movie Plane. The mixing is controlled by metadata embedded with the streams and enables steering of audio as well as attenuation control with the primary and secondary audio streams synchronized to be sample accurate.

### SUMMARY OF THE INVENTION

Therefore a need has arisen for a system and method which selectively includes or removes music vocals from an audio stream of an optical medium for presentation with an instrument accompaniment.

A further need exists for a system and method which selectively presents music lyrics as a visual display synchronized with the instrument accompaniment.

In accordance with the present invention, a system and method are provided which substantially reduce the disadvantages and problems associated with previous methods and systems for presenting audiovisual information from an optical medium in Karaoke modes. Separate audio streams stored on the optical medium are selectively presented to provide a desired Karaoke mode, such as normal presentation, instrumentation presentation without vocals or instrumentation presentation with guide vocals. Visual information presented in synchronization with the audio information allows presentation of lyrics associated with the vocals in a text box of a graphics plane of a display.

More specifically, a Karaoke module manages plural audio streams, synchronization information and a text stream to present audiovisual information in a user selected Karaoke mode. The Karaoke module is, for instance, an application running on an information handling system or in an optical drive, such as a BD-J application retrieved from the optical medium. In one embodiment, a first audio stream includes instrumentation and vocals for music while a second audio stream includes an inverse of the vocals. The inverse vocals are selectively mixed with the first audio stream to remove or subdue the vocals for a presentation of instrumentation, either alone or with guide vocals. In another embodiment, instrumentation is read from a first audio stream of an optical medium and vocals are read from a second audio stream of the optical medium. The instrumentation is selectively rendered alone for an instrumentation mode or with subdued vocals for a guide vocal mode. The separate audio streams are mixed with embedded metadata. In addition, a textual stream is read from the optical medium for visual presentation of lyrics synchronized to instrumentation or guide vocals. The lyrics are, for instance, presented in a text box of a graphics plane of a BD display as text subtitling.

The present invention provides a number of important technical advantages. One example of an important technical advantage is that Karaoke modes are supported in optical media with reduced expense, reduced complexity and greater user convenience. User interaction with various Karaoke modes is managed through an application that is optionally included on the optical medium for reduced complexity of optical drive or information handling system design and control of intellectual property by the manufacturer of the optical medium. Managed presentation of vocals in amplitude and position provide a more rich Karaoke experience. Managed presentation of text subtitles provide improved usability and, in a BD environment, greater flexibility in visual effects. Further, vocals and text may be presented synchronously with actual visuals from musicians in a movie plane. Variations in playback from Karaoke modes are available to enhance playback in normal modes of playback. For instance, an end user may select normal playback of the audio stream with Karaoke presentation of lyrics to better follow lyrics that are otherwise difficult to understand.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of an information handling system configured to present Karaoke information from multiple audio streams;

FIG. 2 depicts a flow diagram of a process for presenting Karaoke information using an inverse vocal audio stream;

FIG. 3 depicts a flow diagram of a process for presenting Karaoke information using separate instrumentation and vocal audio streams;

FIG. 4 depicts a blow-up view of display architecture for presenting vocal lyrics in a text box of a graphics plane; and

FIG. 5 depicts the main and sub path structure for Blu-ray subtitle presentation.

### DETAILED DESCRIPTION

Presentation of Karaoke information from an information handling system by reading and rendering plural audio streams improves user flexibility for applying information stored on an optical medium, such as Blu-ray Disc (BD) medium. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

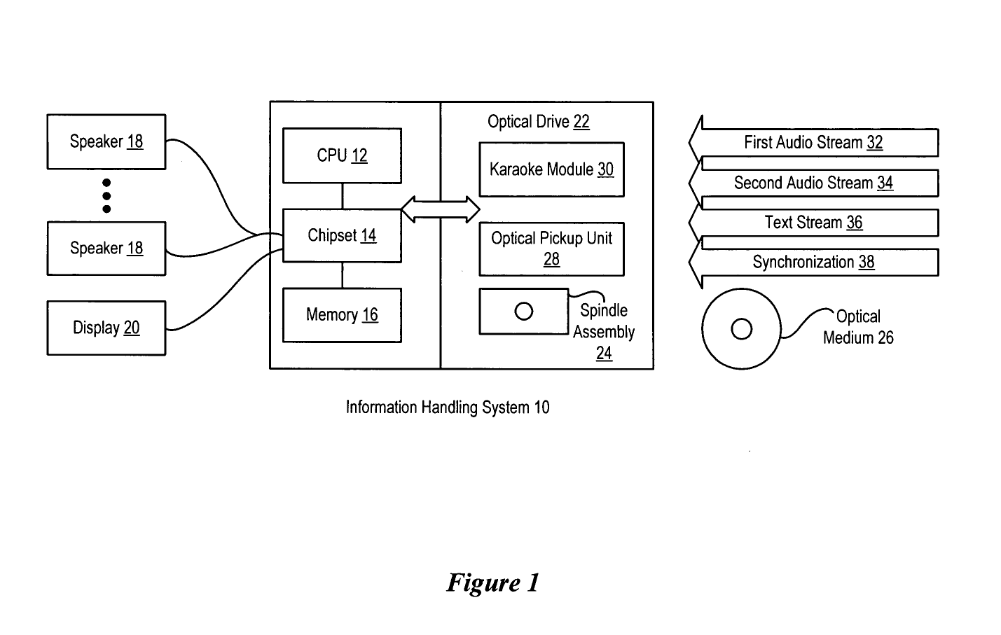

Referring now to FIG. 1, a block diagram depicts an information handling system 10 configured to present Karaoke information from multiple audio streams. Information handling system 10 is built from plural processing components, such as a CPU 12, chipset 14 and memory 16, that cooperate to process audiovisual information for presentation at speakers 18 and a display 20. For example, an optical drive 22 incorporated in information handling system 10 has a spindle assembly 24 that spins an optical medium 26 proximate an optical pickup unit 28 to read audiovisual information. Optical pickup unit 28 includes a laser, such as a blue laser for interacting with BD media, which illuminates optical medium 26 to determine information stored on optical medium 26. The information is rendered either within optical drive 22 or by CPU 12 to produce speaker and display signals representing sounds and images stored on optical medium 26.

A Karaoke module 30 manages information read from optical medium 26 to present audiovisual information in a selected of plural Karaoke modes. Karaoke module 30 is, for instance, firmware or software instructions running on a processing component within optical drive 22 or other portions of information handling system 10. In one embodiment, Karaoke module 30 is an application stored on optical medium 26 and retrieved to run in optical drive 22, such as a BD-J application of the BD specification. Karaoke module 30 presents Karaoke options to a user, such as at display 20, and manages presentation of audiovisual information in the Karaoke mode selected by the user. For instance, the user may select play of music as nominally recorded in a normal mode, may select play of only instrumentation, or may select play of instrumentation with guide vocals in which vocals are subdued or played in selected of the plural speakers, such as one or more speakers in 5.1 or 7.1 audio space. Vocals separated from instrumentation may include all vocals or may leave secondary vocals, such as harmony vocals, with the instrumentation. Audiovisual information is read from optical medium 26 by optical pickup unit 28 as a first audio stream 32 and a second audio stream 34 that Karaoke module 30 uses to present the desired Karaoke mode, as explained in depth below. In addition, a text stream 36 is read that includes lyrics for presentation at display 20, such as in a text box of a graphics mode of the BD specification. Synchronization information is read from optical medium 26 and associated with each stream, such as by metadata embedded in each stream, to support presentation of the streams mixed to be sample accurate.

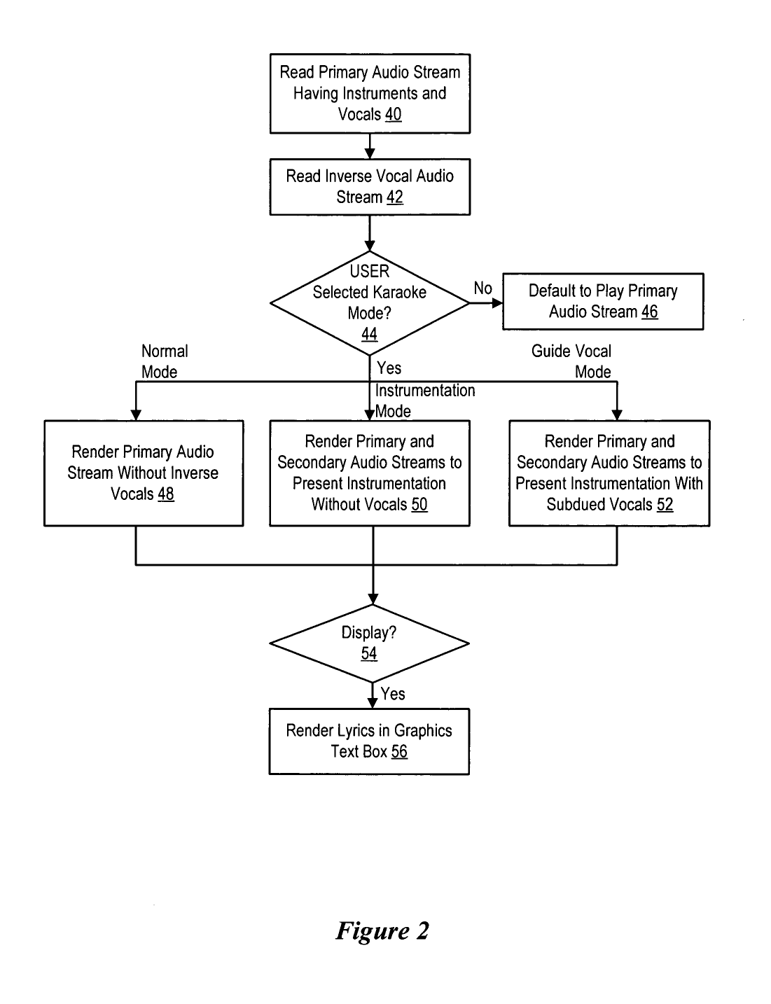

Referring now to FIG. 2, a flow diagram depicts a process for presenting Karaoke information using an inverse vocal audio stream. For this process, the first audio stream 32 stored on optical medium 26 has instrumentation and vocals combined to allow normal play of the music while the second audio stream 34 has an inverse of the vocals. Mixing the inverse vocals with the normal vocals at the same amplitude results in cancellation of the vocals similar to the performance of echo cancellation, while altering the amplitude of the inverse vocals may allow some of the primary vocals to bleed through as guide vocals. Mixing of inverse vocals is essentially subtraction of vocals digitally from an original sound track having the vocals; thus, an alternative embodiment stores the vocals instead of inverse vocals and performs subtraction of the vocals at the optical drive instead of addition of inverse vocals. The process begins at step 40 with reading of the primary audio stream having instrumentation and vocals from the optical medium. The process continues to step 42 for reading of the inverse vocal audio stream from the optical medium. At step 44, a determination is made of whether a user has selected a Karaoke mode. If not, the process continues to step 46 to default by playing the primary audio stream for presentation of the music with unaltered instrumentation and vocals. If the user has selected a Karaoke mode, the process continues to step 48, 50 or 52 based on the user selection. At step 48, a user selection of normal play mode results in rendering of the primary audio stream without inverse vocals for normal playback of unaltered instrumentation and vocals. At step 50, a user selection of instrumentation mode results in rendering of the primary audio stream and secondary audio stream to present instrumentation without vocals. The inverse vocals are rendered by digitally mixing at the same amplitude as the primary vocals to cancel the vocals in the audio output. At step 52, a user selection of guide vocals mode results in rendering of the primary audio stream and secondary audio stream to present instrumentation with vocals that are subdued in volume. The strength of the guide vocals are user selectable by altering the amplitude of the inverse vocals that are mixed with the primary vocals. The process continues to step 54 for a determination of whether a display is present and, if so, to step 56 for rendering of lyrics in a graphics text box synchronized to the vocals. In one alternative embodiment, the secondary audio stream may store instrumentation without vocals instead of inverse vocals to allow user selection of the secondary track for Karaoke playback. In such an alternative embodiment, guide vocals may be provided by mixing the first audio stream at reduced amplitude to, in essence, double play the instrumentation over the vocals.

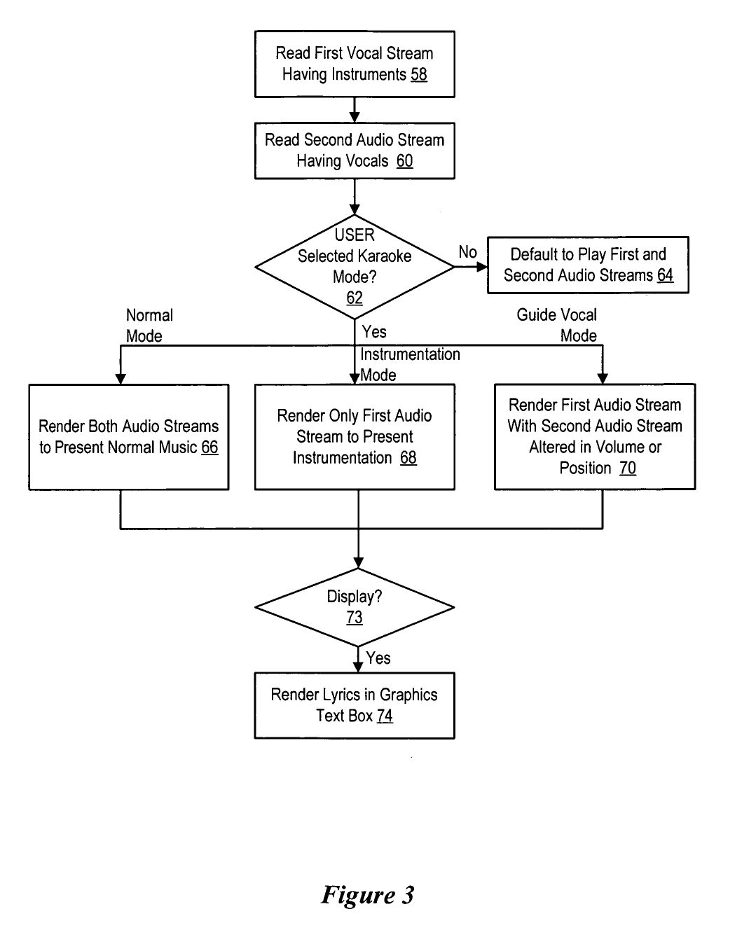

Referring now to FIG. 3, a flow diagram depicts a process for presenting Karaoke information using separate instrumentation and vocal audio streams. For this process, the first audio stream 32 stored on optical medium 26 has instrumentation for music while the second audio stream 34 has vocals of the music. Mixing the instrumentation and vocals at a normal defined amplitude results in presentation of the music as nominally produced, while altering the amplitude of the vocals allows presentation of the music with just instrumentation or with guide vocals having subdued volume. The process begins at step 58 with reading of the primary audio stream having instrumentation from the optical medium. The process continues to step 60 for reading of a secondary audio stream having vocals audio from the optical medium. At step 62, a determination is made of whether a user has selected a Karaoke mode. If not, the process continues to step 64 to default by playing the primary and secondary audio streams at a nominal relative amplitude for presentation of the music in normal mode with unaltered instrumentation and vocals. If the user has selected a Karaoke mode, the process continues to step 66, 68 or 70 based on the user selection. At step 66, a user selection of normal play mode results in rendering of the primary and secondary audio streams for normal playback of unaltered instrumentation and vocals. At step 68, a user selection of instrumentation mode results in rendering of the primary audio stream without the secondary audio stream to present instrumentation without vocals. At step 70, a user selection of guide vocals mode results in rendering of the primary audio stream and secondary audio stream to present instrumentation with vocals that are subdued in volume. The strength of the guide vocals are user selectable by altering the amplitude of the vocals that are mixed with the primary instrumentation. In one alternative embodiment, the positioning of the vocals among plural speakers, such as in a 5.1 or 7.1 audio space, is user selectable for directional based guide vocals. The synchronization is performed with metadata embedded in the audio streams that also supports user selection of positional audio output. The process continues to step 72 for a determination of whether a display is present and, if so, to step 74 for rendering of lyrics in a graphics text box synchronized to the vocals.

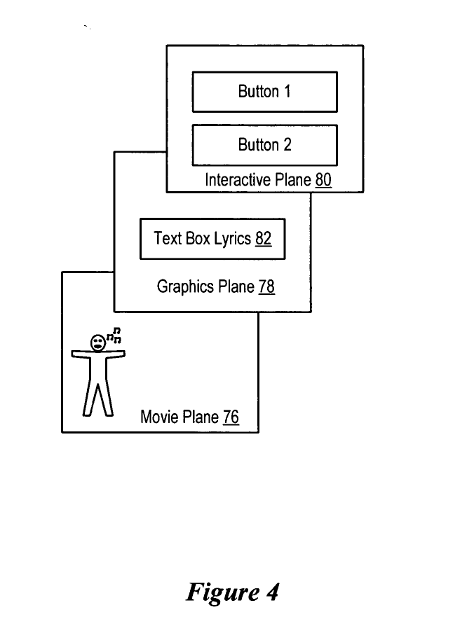

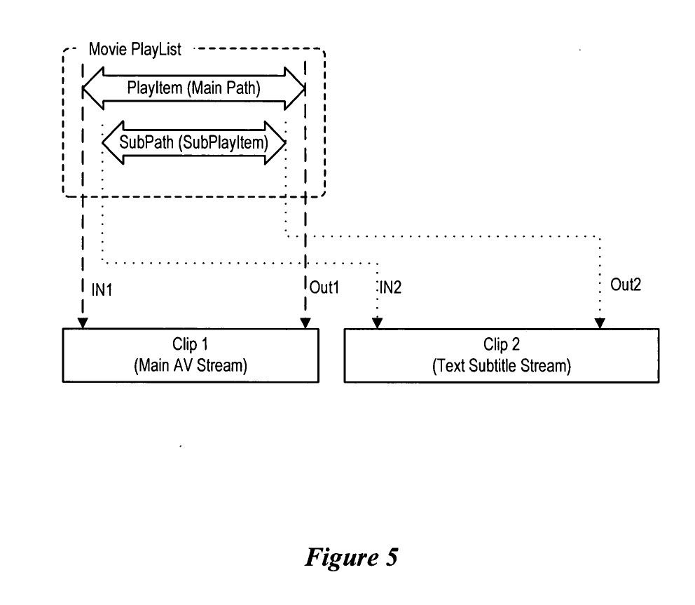

Referring now to FIG. 4, a blow-up view depicts a BD display architecture for presenting vocal lyrics in a text box of a graphics plane. The movie plane 76, graphics plane 78 and interactive plane 80 each have a size of up to 1920 by 1080 pixels that are rendered for presentation over each other. A text box 82 in graphics plane 78 provides textual presentation of lyrics from an optical medium that are synchronized with audio streams of the optical medium by embedded metadata, such as a presentation time stamp. The graphics plane allows text to have a variety of effects, such as fades, wipes, scrolls, color changes, fonts, size and position of the text box. FIG. 5 depicts the main and sub path structure for Blu-ray subtitle presentation of lyrics. The text subtitle stream is an out of band stream to the main transport stream but is synchronized to the main audiovisual presentation in movie plane 76. Thus, lyrics and vocals are presentable with a movie of performers and managed by a Karaoke module under user control.

Although the present invention has been described in detail, it should be understood that various changes, substitutions and alterations can be made hereto without departing from the spirit and scope of the invention as defined by the appended claims.

What is claimed is:

1. A method for presenting audio information stored on an optical medium, the method comprising:
reading a first audio stream from the optical medium;
reading a second audio stream from the optical medium;
mixing the first and second audio streams; and
selecting one of plural Karaoke options to render the first and second audio streams for selected presentation of instrumentation and vocals.

2. The method of claim 1 wherein the first audio stream comprises music with instrumentation and vocals and the second audio stream comprises an inverse image of the vocals, and wherein selecting one of plural Karaoke options further comprises rendering the first and second audio streams to cancel the vocals and present the instrumentation.

3. The method of claim 1 wherein the first audio stream comprises music with instrumentation and vocals and the second audio stream comprises an inverse image of the vocals, and wherein selecting one of plural Karaoke options further comprises rendering the first and second audio streams to reduce the vocals and present the instrumentation with guide vocals.

4. The method of claim 3 wherein the vocals are reduced in response to an application provided by the optical medium.

5. The method of claim 4 wherein the optical medium comprises a BD optical medium and the application comprises a BD-J application.

6. The method of claim 1 wherein the first audio stream comprises music with instrumentation and vocals and the second audio stream comprises an inverse image of the vocals, and wherein selecting one of plural Karaoke options further comprises rendering the first audio stream without the second audio stream to present the vocals and the instrumentation as stored by the first audio stream.

7. The method of claim 1 wherein the first audio stream comprises music instrumentation and the second audio stream comprises music vocals, and wherein selecting one of plural Karaoke options further comprises rendering the first audio stream without the second audio stream to present instrumentation without vocals.

8. The method of claim 1 wherein the first audio stream comprises music instrumentation and the second audio stream comprises music vocals, and wherein selecting one of plural Karaoke options further comprises rendering the first audio stream with the second audio stream to present instrumentation with vocals.

9. The method of claim 8 further comprising altering the second audio stream to present the vocals as guide vocals.

10. The method of claim 9 wherein altering the second audio stream further comprises adjusting the amplitude of the vocals to provide Karaoke guide vocals.

11. The method of claim 9 wherein altering the second audio stream further comprises selectively placing the second audio stream in one or more of plural speakers to provide Karaoke guide vocals.

12. The method of claim 1 wherein the first audio stream comprises music instrumentation and the second audio stream comprises music vocals, and wherein selecting one of plural Karaoke options further comprises running an application stored on the optical medium, the application operable to accept user inputs to play music instrumentation alone, to play music instrumentation with altered music vocals, or to play music instrumentation with music vocals unaltered.

13. The method of claim 12 wherein the optical medium comprises a BD optical medium and the application comprises a BD-J application.

14. The method of claim 1 wherein the first audio stream comprises music instrumentation and music vocals and the second audio stream comprises music instrumentation without music vocals, and wherein selecting one of plural Karaoke options further comprises playing the second audio stream to present Karaoke music instrumentation.

15. The method of claim 1 further comprising:
reading vocal lyrics stored as text on the optical medium;
synchronizing the lyrics with the audio streams; and
presenting the lyrics at a display synchronized with presentation of the vocals.

16. The method of claim 15 wherein the vocal lyrics are stored as text subtitle information presented as a text box in a graphics plane.

17. An optical medium comprising:
a first audio stream having first audio information;
a second audio stream having second audio information;
synchronization information defining synchronization of the first and second audio streams; and
an application having Karaoke instructions readable by an information handling system, the Karaoke instructions operable to selectively mix the first and second audio streams as a Karaoke presentation selected by a user.

18. The optical medium of claim 17 wherein the application comprises a BD-J application.

19. The optical medium of claim 17 wherein:
the first audio stream information comprises instrumentation and vocals;
the second audio stream information comprises an inverse of the vocals; and
the application selectively mixes the first and second audio streams to provide the Karaoke presentation selected by the user.

20. The optical medium of claim 19 wherein the Karaoke presentation selected by the user comprises presentation of instrumentation without vocals.

21. The optical medium of claim 19 wherein the Karaoke presentation selected by the user comprises presentation of instrumentation with subdued guide vocals.

22. The optical medium of claim 17 wherein:
the first audio stream information comprises instrumentation;
the second audio stream information comprises vocals; and
the application selectively plays the first audio stream without the second audio stream to provide Karaoke instrumentation.

23. The optical medium of claim 17 wherein:
the first audio stream information comprises instrumentation;
the second audio stream information comprises vocals; and
the application selectively plays the first audio stream with the second audio stream subdued to provide Karaoke instrumentation with guide vocals.

24. The optical medium of claim 17 wherein:
the first audio stream information comprises instrumentation;
the second audio stream information comprises vocals; and
the application selectively plays the first audio stream with the second audio stream at plural speakers, at least one speaker having the amplitude of the first and second audio streams varied to provide Karaoke instrumentation with guide vocals.

25. The optical medium of claim 17 further comprising a text subtitle stream having lyrics synchronized with the first and second audio stream, the lyrics presentable during presentation of the first and second audio stream.

26. An information handling system comprising:
plural processing components operable to process audio information and present the audio information at one or more speakers;
a spindle assembly operable to spin an optical medium;
an optical pickup unit proximate the spindle, the optical pickup unit operable to illuminate the optical medium with a laser and read reflections from the optical medium to determine information stored on the optical medium; and
a Karaoke module interfaced with the processing components and the optical pickup unit, the Karaoke module operable to read first and second audio streams from the optical medium for presentation by the processing components in a Karaoke mode selected by a user.

27. The information handling system of claim 26 wherein the Karaoke module further comprises an application from the optical medium, the application operable to run on the processing components to manage reading of the first and second audio streams to generate the presentation in the Karaoke mode.

28. The information handling system of claim 26 wherein the first optical stream comprises instrumental and vocal information, the second optical stream comprises inverse vocal information, and the Karaoke module presents a Karaoke instrument mode by mixing the first and second audio streams to cancel the vocal information.

29. The information handling system of claim 26 wherein the first optical stream comprises instrumental and vocal information, the second optical stream comprises inverse vocal information, and the Karaoke module presents a Karaoke instrument mode with guide vocals by mixing the first and second audio streams to subdue the vocal information.

30. The information handling system of claim 26 wherein the first optical stream comprises instrumental information, the second optical stream comprises vocal information, and the Karaoke module presents a Karaoke instrument mode by presenting the first audio stream without the second audio stream.
